(19) United States
(12) Patent Application Publication
(10) Pub. No.: US 2007/0070211 A1
(43) Pub. Date: Mar. 29, 2007

(54) Composite monitoring and video recording apparatus

(76) Inventor: Yi-Chia Liao, Miaoli County (TW)

Correspondence Address: BIRCH STEWART KOLASCH & BIRCH, PO BOX 747, FALLS CHURCH, VA, 22040-0747, US

(21) Appl. No.: 11/237,921

(22) Filed: Sep. 29, 2005

(51) Int. Cl. H04N 5/225; G03B 17/00

(52) U.S. Cl. 348/220.1; 396/427

(57) ABSTRACT

A composite monitoring and video recording apparatus integrates a camera and a storage device to perform burglar-thwarting picture taking operation through a human body infrared sensor. The storage device can perform cyclic recording function to constantly store latest images. The lens of the apparatus can perform dynamic continuous video recording or static picture taking in a one by one fashion according to the intensity of external light.

### FIELD OF THE INVENTION

The present invention relates to a monitoring apparatus and particularly to a composite monitoring and video recording apparatus that integrates video recording, picture taking and storage devices for operating a long period of time.

### BACKGROUND OF THE INVENTION

The conventional monitoring or video recording apparatus generally have a camera and a storage device that are separated and installed on two spaces. They take pictures in an one by one fashion to get high resolution images, or capture dynamic video images through a continuous picture taking process. The continuous picture taking process can get valuable dynamic pictures even in a poor illuminating environment. But it needs a greater storage space. Moreover, the conventional storage method has to use the conventional video recorder or computer hard disks. The conventional video recorder has to replace video tapes periodically and records only sequentially. The computer hard disk has a limited life span and is easily damaged due to environmental factors. All of this creates problems in repairs and maintenance.

### SUMMARY OF THE INVENTION

Therefore the primary object of the present invention is to couple a camera and a storage device together through a control circuit to reduce space, and use a semiconductor solid state memory device as a storage medium to reduce maintenance cost.

Another object of the invention is to detect external light through a light intensity sensor so that different picture taking methods are used corresponding to different light intensities.

The foregoing, as well as additional objects, features and advantages of the invention will be more readily apparent from the following detailed description, which proceeds with reference to the accompanying drawings.

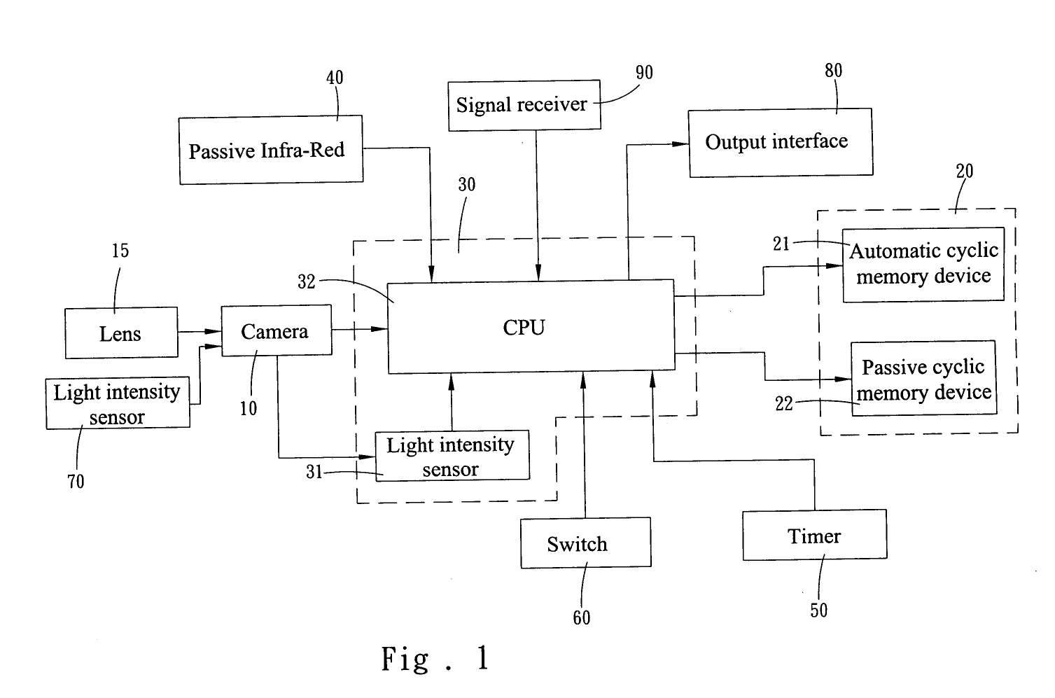

### BRIEF DESCRIPTION OF THE DRAWINGS FIG. 1 a block diagram for element coupling according to the present invention.

### DETAILED DESCRIPTION OF THE PREFERRED EMBODIMENT

Please refer to FIG. 1, the invention includes a camera 10, a lens 15, at least one storage device 20 and a control circuit 30. The storage device 20 aims to store images captured by the lens 15. The control circuit 30 includes a light intensity sensor 31 and a central processing unit (CPU) 32. The lens 15 may contain charge-coupled device (CCD) or complementary metal oxide semiconductor (CMOS) elements. The storage device 20 may be a semiconductor solid state memory device (such as CF card) or micro hard disk.

The CPU 32 aims to issue or receive signals of the lens 15, light intensity sensor 31 and storage device 20. The lens 15 is located on the camera 10 and receives signals from the CPU 32 to control and perform picture taking operation.

The light intensity sensor 31 detects the intensity of external light to determine emission of signals to the CPU 32 to perform still picture taking or dynamic picture taking operation. The CPU 32 issues a control signal to the lens 15 to perform either still picture taking or dynamic picture taking operation. For instance, in the event that the light intensity sensor 31 detects a stronger light intensity, a signal for still picture taking operation is sent to the CPU 32 which issues the control signal to the lens 15 so that the lens 15 takes pictures in a static fashion by a time interval such as one or three seconds. On the other hand, if the light intensity sensor 31 detects a weaker light intensity, another signal for dynamic picture taking operation is sent to the CPU 32 which issues another control signal to the lens 15 so that the lens 15 takes continuous pictures in a dynamic fashion. Hence an optimum result can be achieved through different picturing taking processes according to different environments.

The CPU 32 may be connected to a human body infrared sensor which is a Passive Infra-Red (PIR) 40. When the PIR 40 detects passing of a human body, it notices the CPU 32 which issues a signal to the lens 15 to proceed picture taking operation. And the captured image data are stored in the storage device 20.

The CPU 32 may be connected to an external output interface 80 to couple with a computer or TV to immediately display the captured pictures so that guards can see and monitor.

The storage device 20 includes an automatic cyclic memory device 21 and a passive cyclic memory device 22. When the automatic cyclic memory device 21 runs out of storage capacity, the CPU 32 issues a control signal to the automatic cyclic memory device 21 to start storing from a beginning position and overlap the existing data. Hence the automatic cyclic memory device 21 can perform recording function in a cyclic fashion to store the latest images, and avoid loss of images due to not adequate storage capacity of the storage device 20.

The passive cyclic memory device 22 may be controlled by a timer 50. The timer 50 can be set for a start time value A, a stop time value B, and an update time interval value C. When the timer 50 detects the start time value A, the CPU 32 issues a signal to the lens 15 to store the captured image data in the passive cyclic memory device 22.

When the timer 50 detects the stop time value B, the CPU 32 issues another signal to the lens 15 to store the captured image data in the automatic cyclic memory device 21. Hence the images captured during the interval of the start time value A and the stop time value B are specifically stored in the passive cyclic memory device 22.

When the passive cyclic memory device 22 runs out of data storage capacity, and the time of the captured images stored in the beginning position exceeds the update time interval value C, the CPU 32 issues another signal to the passive cyclic memory device 22 so that it stores the data from the beginning position and overlaps the existing data to constantly store the latest images. For instance, if the update time interval value C is set three days or one week; when the passive cyclic memory device 22 runs out of capacity and the captured images stored on the beginning position exceeds three days or one week, the CPU 32 issues another signal to the passive cyclic memory device 22 so that data are stored on the passive cyclic memory device 22 from the beginning position and overlap the existing data.

The invention may further include a switch button 60 to decide whether to activate the passive cyclic memory device 22 through the timer 50. To facilitate operation, the CPU 32 is connected to a signal receiver 90 so that the CPU 32 can be receive a control signal triggered by a remote controller operated manually to determine whether the images captured by the lens 15 are to be stored in the passive cyclic memory device 22.

The camera 10 may also include another light intensity sensor 70 to detect the intensity of the external light, and sends a signal to the light intensity sensor 31 in the control circuit 30 to detect the intensity of the existing external light. The another light intensity sensor 70 may include a photosensitive resistor (CDS) or a photoelectric transistor. It is to be noted that the light source of the external light detected by light intensity sensor 31 can be provided by the lens 15.

What is claimed is:

1. A composite monitoring and video recording apparatus, comprising:
a camera;
a lens located on the camera;
at least one storage device for storing images captured by the lens; and
a control circuit which includes a light intensity sensor and a central processing unit (CPU) which issues or receives signals of the lens, the light intensity sensor and the storage device, the lens receiving signals from the CPU to control picture taking operation, the light intensity sensor determining to issue a signal to the CPU to perform either a static picture taking operation or a dynamic picture taking operation according to detection of the intensity of an external light so that the CPU issues a control signal to the lens to perform either the static picture taking operation or the dynamic picture taking operation.

2. The composite monitoring and video recording apparatus of claim 1, wherein the CPU is connected to a Passive Infra-Red (PIR) which detects passing of a human body and triggers the CPU to issue a detection signal to the lens to perform picture taking operation and store image data in the storage device.

3. The composite monitoring and video recording apparatus of claim 1, wherein the control circuit is connected to an external output interface to couple with a computer or a TV.

4. The composite monitoring and video recording apparatus of claim 1, wherein the storage device includes an automatic cyclic memory device and a passive cyclic memory device.

5. The composite monitoring and video recording apparatus of claim 4, wherein the CPU issues a control signal to the automatic cyclic memory device when the capacity of the automatic cyclic memory device runs out to start storing from a beginning position and overlap existing data so that a cyclic recording function is performed to constantly store latest images.

6. The composite monitoring and video recording apparatus of claim 4, wherein the passive cyclic memory device is controlled by a timer which sets a start time value A, a stop time value B and a update time interval value C, the CPU issuing a signal to the lens to store captured image data in the passive cyclic memory device when the timer reaches the start time value A; the CPU issuing another signal to the lens to store the captured image data in the automatic cyclic memory device when the timer reaches the stop time value B; and the CPU issuing yet another signal to the lens to store the captured image data in the passive cyclic memory device from a beginning position and overlap existing data when the capacity of the passive cyclic memory device runs out and the time of the images stored on the beginning position exceeds the updated time interval C.

7. The composite monitoring and video recording apparatus of claim 6 further including a switch button to determine whether to activate the passive cyclic memory device through the timer.

8. The composite monitoring and video recording apparatus of claim 4 further including a signal receiver to allow the CPU to receive a trigger signal generated manually by users so that image data captured by the lens are stored in the passive cyclic memory device.

9. The composite monitoring and video recording apparatus of claim 1, wherein the camera includes another light intensity sensor to detect the intensity of the external light to issue a signal to the light intensity sensor in the control circuit.

10. The composite monitoring and video recording apparatus of claim 9, wherein the another light intensity sensor is a photosensitive resistor (CDS).

11. The composite monitoring and video recording apparatus of claim 9, wherein the another light intensity sensor is a photoelectric transistor.

12. The composite monitoring and video recording apparatus of claim 1, wherein the source of the external light detected by the light intensity sensor is provided by the lens.

13. The composite monitoring and video recording apparatus of claim 1, wherein the lens can be selected from a charge-coupled device (CCD) and a complementary metal oxide semiconductor (CMOS).

14. The composite monitoring and video recording apparatus of claim 1, wherein the storage device is selectively a semiconductor solid state memory device or a micro hard disk.
